(19) United States
(12) Patent Application Publication
(10) Pub. No.: US 2025/0116304 A1
(43) Pub. Date: Apr. 10, 2025

(54) BRAKING DEVICE

(71) Applicant: Brembo S.p.A., Curno, Bergamo (IT)

(72) Inventors: Gianluigi MARONATI, Curno, Bergamo (IT); Giovanni RIZZOLO, Curno, Bergamo (IT); Nino RONCHI, Curno, Bergamo (IT); Massimo DAMIANI, Curno, Bergamo (IT); Francesco TORRESE, Curno, Bergamo (IT)

(21) Appl. No.: 18/730,343

(22) PCT Filed: Jan. 19, 2023
(86) PCT No.: PCT/IB2023/050453

§ 371 Date: Jul. 19, 2024

(30) Foreign Application Priority Data
Jan. 19, 2022 (IT) 102022000000794
Jan. 19, 2022 (IT) 102022000000800
Jan. 19, 2022 (IT) 102022000000806
Jan. 19, 2022 (IT) 102022000000809

(51) Int. Cl. F16D 65/12; F16D 65/02; F16D 65/847

(52) U.S. Cl. CPC F16D 65/123; F16D 65/847; F16D 2065/1328; F16D 2065/1384

(57) ABSTRACT

A braking device for a vehicle unusually capable of determining a high heat exchange efficiency may have a disc brake disc with a braking band. The braking band may have two opposite plates. The plates are connected to each other by pins which delimit a ventilation duct with the plates. The disc brake also has a driving bell adapted to connect to a stub axle of a vehicle. In ventilation duct there is at least one radial connection extension which connects the two opposite plates and connects the braking band to the driving bell so that the braking band and the driving bell are in one piece. The at least one radial connecting extension faces with a portion thereof and on both of its circumferentially directed sides on two axial through windows, which are through openings directed in an axial direction and which both communicate with said ventilation duct.

### FIELD OF THE INVENTION

The present invention relates to braking devices comprising brake discs suited to vehicles.

In particular, the present invention relates to braking devices suffering from the overheating problem mainly due to their small footprint.

### BACKGROUND ART

In a disc brake, the brake caliper is generally arranged straddling the outer peripheral margin of a brake disc, adapted to rotate about a rotation axis (A-A) defining an axial direction (X-X). In a disc brake, a radial direction (R-R), substantially orthogonal to said axial direction (X-X), and a tangential (C-C) or circumferential (C-C) direction, orthogonal to both said axial direction (X-X) and said radial direction (R-R), are further defined.

Brake calipers are constrained to a support structure, which remains stationary with respect to the vehicle wheel, e.g., such as a stub axle of a vehicle suspension, or a vehicle wheel hub, or a fork. The brake caliper usually comprises a caliper body having two elongated portions arranged so as to face opposite braking surfaces of a brake disc, and at least one bridge, which connects said two elongated portions to each other. Appropriately actuated calipers press the pads against the braking band and the braking action is produced by the friction between the pads and the braking band of the brake disc.

A disc brake device solution is known from document EP 1 122 456 B1 to the same Applicant and shows features according to the preamble of claim 1.

This known solution, despite being optimized to achieve other objectives, including an improved expansion of the braking band where it is heated by the braking action, is not optimized to eliminate or minimize overheating, in particular, if the brake disc is intended for small spaces. Furthermore, this solution is not suited to the application of a parking braking actuation on the same device, e.g., by means of a shoe device inserted into the driving bell and acting on an inner cylindrical surface thereof.

Other similar solutions are known from EP 1 092 889 A1 as well as from EP 0 680 571 B1, DE 19528434 A1, U.S. Pat. No. 5,823,303 A.

Solutions adapted to increase the heat exchange between the braking band of the ventilated type and the air passing through the ventilation duct inside the braking band have also been suggested.

For example, document NO 2012/164465 A1 shows circular protuberances or bosses provided in the radially outer periphery of the ventilation duct.

Document EP 2 192 321 A1 shows circular protuberances or bosses provided in the radially inner periphery of the ventilation duct.

Document DE 102012024298 A1 shows similar protuberances provided in the ventilation duct.

Document EP 2 469 117 A1 shows pins for connecting the two plates of an elongated braking band and oriented to be inclined at different angles to divert the cooling airflow. However, this solution diverts the air using the walls of the pins obstructing the ventilation duct in the entire axial extension, thus creating poor cooling airflow zones and thus an uneven heat exchange, leading to dangerous hot spots in the brake disc mass, which can lead to the onset of localized expansions and thus localized ruptures.

Connections of the driving bell to the connecting fins of the braking band plates are known from documents EP 0 403 799 A2, NP 0 680 571 B1 or U.S. Pat. No. 5,161,652 A. Again, the connection of radial extensions of the driving bell with fins completely diverts the cooling air creating poor airflow zones or shadow zones resulting in localized overheating points in the brake disc, leading to dangerous hot spots in the brake disc mass which can lead to the onset of localized expansions, and thus localized ruptures.

Therefore, the need to find braking band and brake disc geometries which allow having optimized ventilation ducts when the brake disc is required to have a small footprint, e.g., due to lack of space within a wheel rim, leading to the onset of cooling problems, remains strongly felt.

This cooling problem is accentuated where the driving bell also forms an inner cylindrical surface for a parking brake, e.g., of the Drum In Hat or DIH type. In this case, the axial bell extension is elongated, worsening the entry of air into the brake disc ventilation duct and leading to even more pronounced overheating of the brake disc.

The problem is further accentuated by the presence of the dust boots and the presence of the brake caliper itself placed straddling the brake disc.

### Solution

The present invention aims to provide a braking device in which the tendency to overheat is reduced.

These and other objects and advantages are achieved by a disc brake according to claim 1.

Some advantageous embodiments are the subject of the dependent claims.

From the analysis of this solution, it was found that the suggested solution allows achieving much higher ventilation and especially heat exchange between the braking band and the cooling air than the solutions of the prior art.

### DRAWINGS

Further features and advantages of the device, the disc brake, and the vehicle will become apparent from the following description of preferred embodiments thereof, given by way of non-limiting indication, with reference to the accompanying drawings, in which:

FIG. 1 shows a wheel-side axonometric view of a disc brake disc according to the invention;

FIG. 2 shows a vehicle-side axonometric view of the disc brake disc in FIG. 1;

FIG. 3 shows an axonometric section view of the disc brake disc in FIG. 1 in a plane passing through the centerline of the ventilation duct;

FIG. 4 shows a front section view of the disc brake disc in FIG. 1 in a plane passing through the centerline of the ventilation duct;

FIG. 5 shows an enlarged detail of the section in FIG. 4;

FIG. 6 shows a front section view of a disc brake disc in a plane passing through the centerline of the ventilation duct according to a further embodiment;

FIG. 7 shows an enlarged detail of the section in FIG. 6;

FIG. 8 shows an axonometric section view of a disc brake disc in a plane passing through the rotation axis and in a radial direction according to a still further embodiment;

FIG. 9 shows a front section view of a disc brake disc in FIG. 8 in a plane passing through the rotation axis and in a radial direction;

FIG. 10 shows a front section view of a disc brake disc in a plane passing through the centerline of the ventilation duct according to a still further embodiment;

FIG. 11 shows an enlarged detail of the section in FIG. 10;

FIG. 12 shows an axonometric section view of a disc brake disc in a plane passing through the rotation axis and in a radial direction according to a still further embodiment;

FIG. 13 diagrammatically shows a section view of a detail of a disc brake disc in a plane passing through the centerline of the ventilation duct according to a still further embodiment, as well as a corresponding view according to a radial direction from the inner edge of the braking band of the same disc brake disc;

FIG. 14 diagrammatically shows a section view of a detail of a further disc brake disc in a plane passing through the centerline of the ventilation duct according to a still further embodiment, as well as a corresponding view according to a radial direction from the inner edge of the braking band of the same disc brake disc;

FIGS. 15 and 16 diagrammatically show a section view of a detail of a further disc brake disc in a plane passing through the centerline of the ventilation duct according to a still further embodiment, as well as a corresponding view according to a radial direction from the inner edge of the braking band of the same disc brake disc;

FIGS. 17 and 18 diagrammatically show a section view of a detail of a further disc brake disc in a plane passing through the centerline of the ventilation duct according to a still further embodiment, as well as a corresponding view according to a radial direction from the inner edge of the braking band of the same disc brake disc;

FIGS. 19 and 20 diagrammatically show a section view of a detail of a further disc brake disc in a plane passing through the centerline of the ventilation duct according to a still further embodiment, as well as a corresponding view according to a radial direction from the inner edge of the braking band of the same disc brake disc;

FIGS. 21 and 22 diagrammatically show a section view of a detail of a further disc brake disc in a plane passing through the centerline of the ventilation duct according to a still further embodiment, as well as a corresponding view according to a radial direction from the inner edge of the braking band of the same disc brake disc;

FIGS. 23 and 24 diagrammatically show a section view of a detail of a further disc brake disc in a plane passing through the centerline of the ventilation duct according to a still further embodiment, as well as a corresponding view according to a radial direction from the inner edge of the braking band of the same disc brake disc;

FIG. 25 shows a section view of a detail of a disc brake disc according to a plane passing through the rotation axis of a disc brake disc according to a still further embodiment where the bell connects to the braking band;

FIG. 26 shows a section view of a detail of a disc brake disc according to a plane passing through the rotation axis of a disc brake disc according to a still further embodiment where the bell connects to the braking band;

FIG. 27 shows a section view of a detail of a disc brake disc according to a plane passing through the rotation axis of a disc brake disc according to a still further embodiment where the bell connects to the braking band.

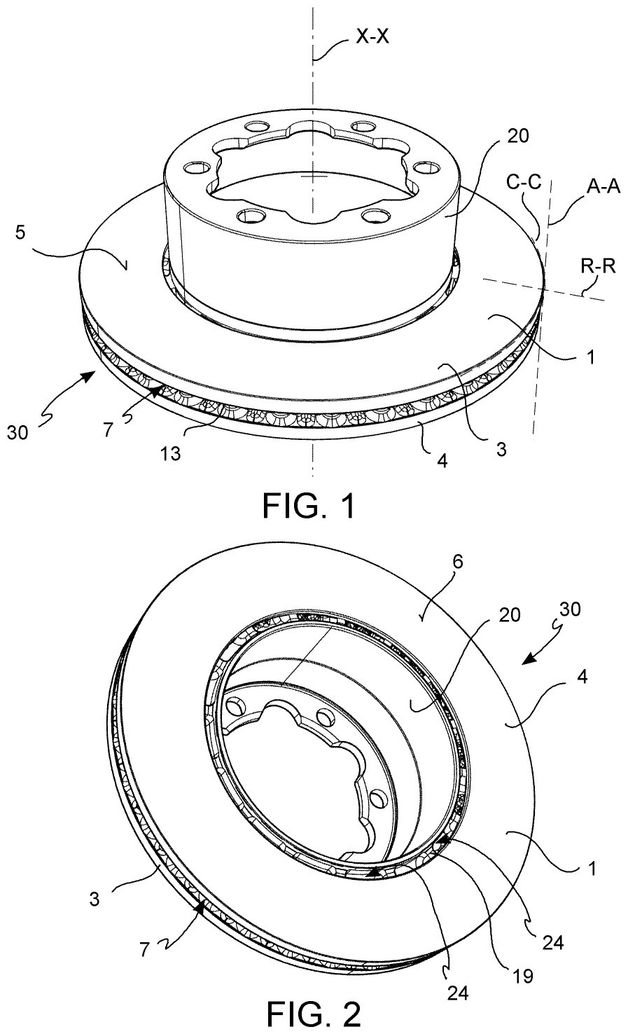

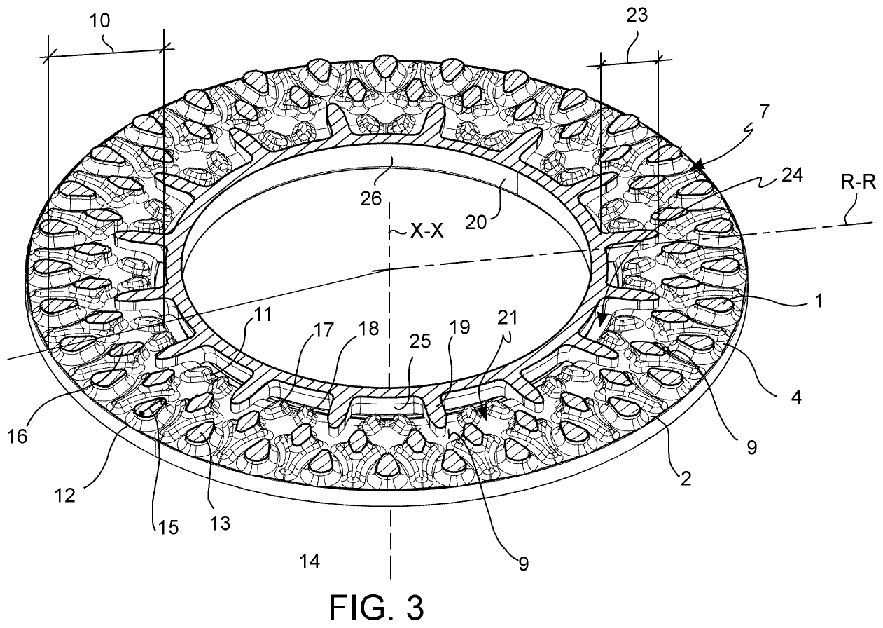

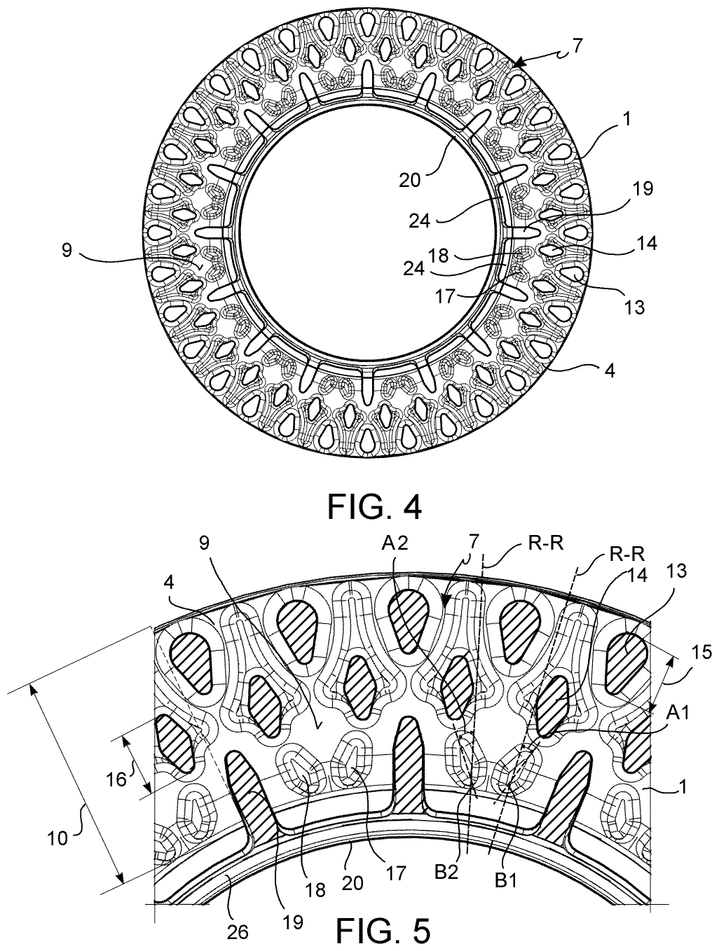

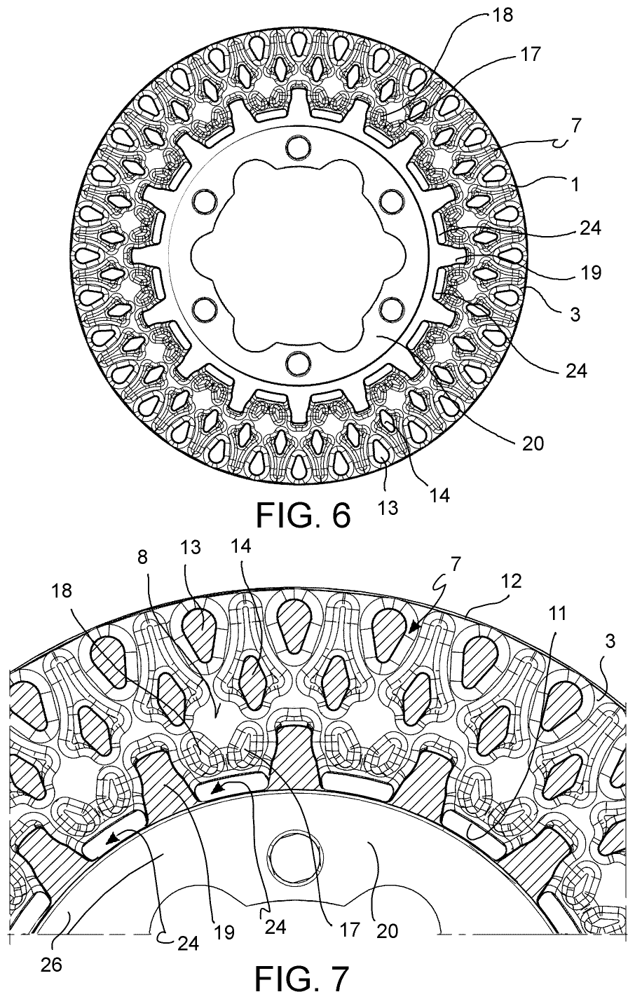

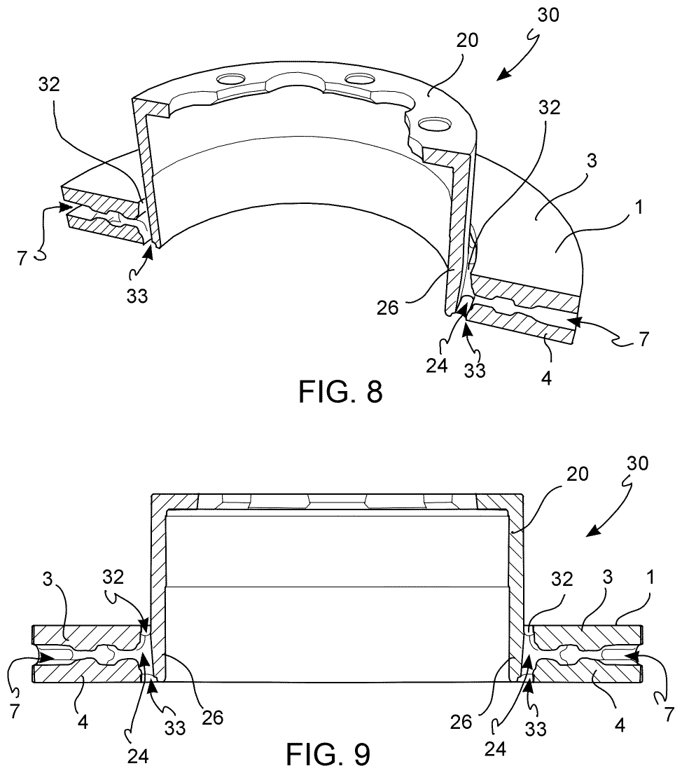

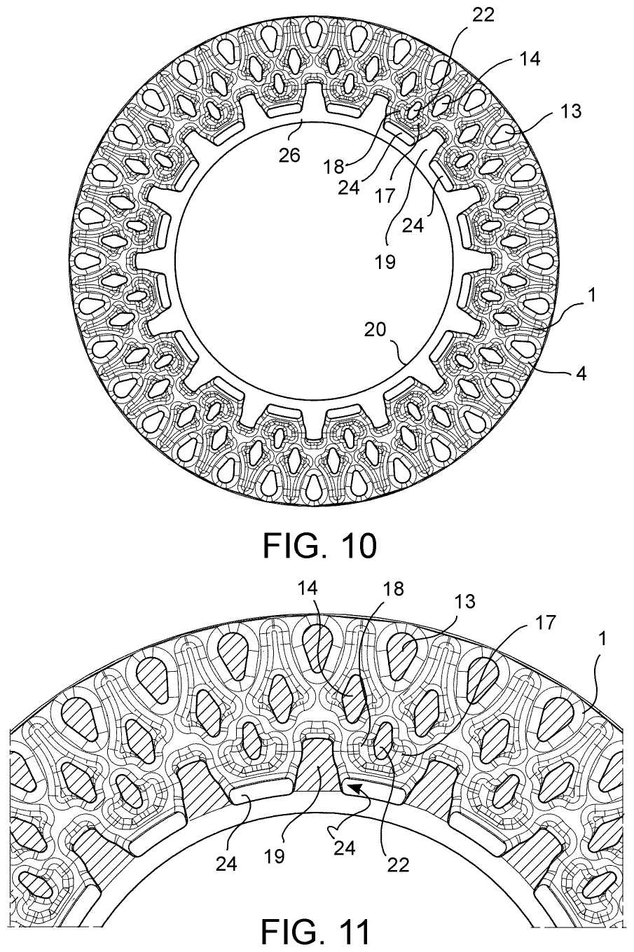

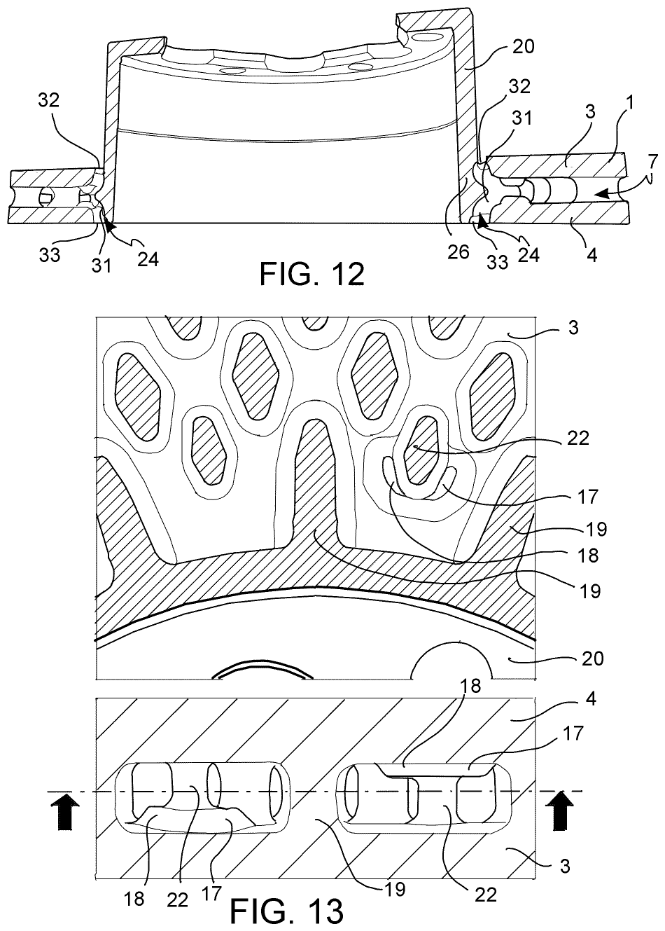

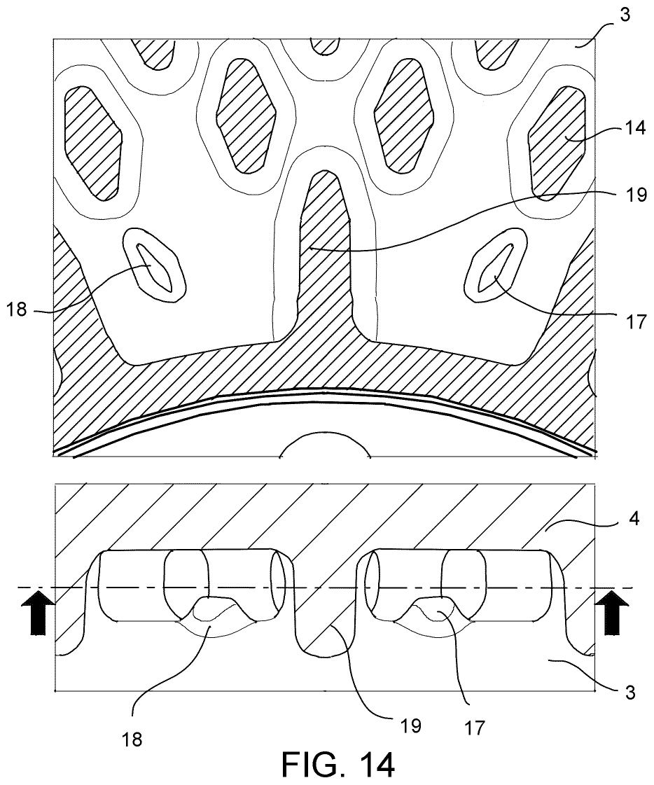

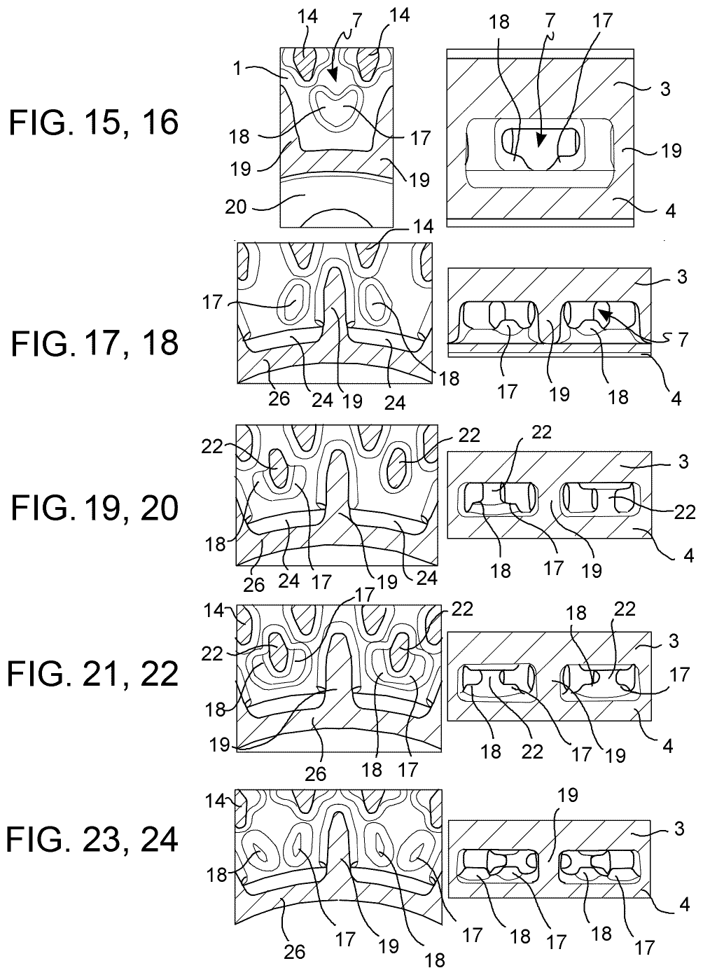

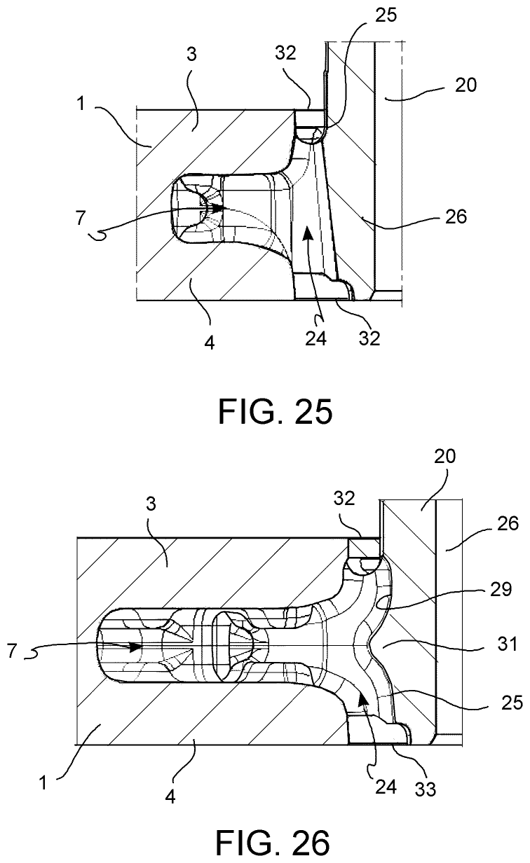

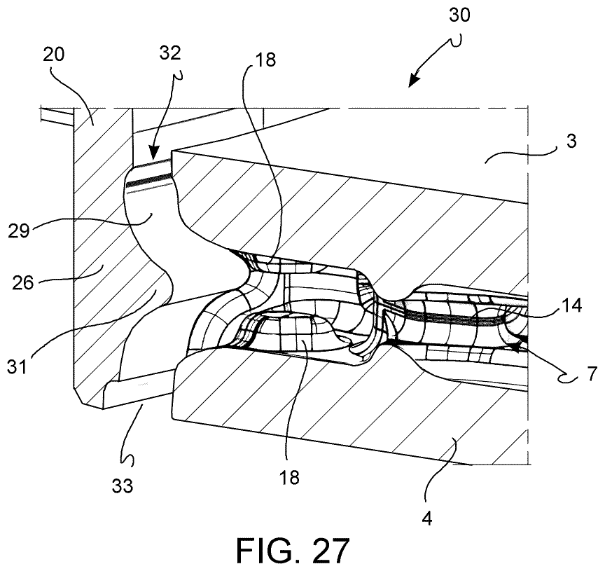

### DESCRIPTION OF SOME PREFERRED EMBODIMENTS

A braking device is provided according to a general embodiment.

According to a general embodiment, a braking band 1 of a brake disc of a disc brake comprises a band body 2 adapted to rotate about a rotation axis X-X.

Said rotation axis defines an axial direction A-A, either coinciding with or parallel to said rotation axis X-X, a radial direction R-R orthogonal to said rotation axis X-X and orthogonal to any axial direction A-A incident with said radial direction R-R, as well as a circumferential direction C-C orthogonal to both said axial direction A-A and said radial direction R-R in any intersection point.

Said braking band 1 comprises two opposite plates 3, 4, which define opposite braking surfaces 5, 6 and substantially flat opposite inner surfaces 8, 9; a ventilation duct 7 delimited by said substantially flat opposite inner surfaces 8, 9 is provided between said plates 3, 4.

Said ventilation duct 7 has a predetermined radial ventilation duct extension 10 extended in a radial direction R-R extending from an inner band edge 11 to an outer band edge 12.

Said plates 3, 4 are connected to each other by pins 13, 14.

Each of said pins 13, 14 has a radial pin extension 15, 16 of smaller magnitude than said radial ventilation duct extension 10.

Close to said inner band edge 11, at least a first inclined boss 17 protrudes from at least one of said opposite inner surfaces 8, 9 towards the inside of said ventilation duct 7 without reaching the opposite inner surface 9, 8.

Said at least a first inclined boss 17 forms a narrowing in said ventilation duct 7.

Said at least a first inclined boss 17 has an elongated extension along a first boss direction B1.

Said first boss direction B1 is inclined with respect to said radial direction R-R as well as with respect to said circumferential direction C-C forming a first acute angle A1 with said radial direction R-R.

Close to said inner band edge 11, at least a second inclined boss 18 protrudes from at least one of said opposite inner surfaces 8, 9 towards the inside of said ventilation duct 7 without reaching the opposite inner surface 9, 8; said at least a second inclined boss 18 forms a narrowing in said ventilation duct 7.

Said at least a second inclined boss 18 has an elongated extension along a second boss direction B2.

Said second boss direction B2 is inclined with respect to said radial direction R-R as well as with respect to said circumferential direction C-C forming a second acute angle A1 with said radial direction R-R.

The inclination of said second boss direction B2 with respect to the radial direction R-R is opposite to the inclination of said first boss direction B1 with respect to the same radial direction R-R.

According to an embodiment, said at least a second inclined boss 18 protrudes from the same inner surface 8 or 9 of said at least a first inclined boss 17.

According to an embodiment, said at least a second inclined boss 18 faces said at least a first inclined boss 17 in a circumferential direction C-C.

According to an embodiment, a radial connection extension 19 which connects said braking band to a driving bell 20 adapted to connect said braking band to a stub axle of a vehicle is interposed in the circumferential direction C-C between said at least a second inclined boss 18 and said at least a first inclined boss 17.

According to an embodiment, said at least a second inclined boss 18 protrudes from the inner surface 9 or 8 opposite to the inner surface 8 or 9 from which said at least a first inclined boss 17 protrudes.

According to an embodiment, said first inclined boss 17 is a plurality of first inclined bosses 17.

Said second inclined boss 18 is a plurality of second inclined bosses 18.

Each of said second inclined bosses 18 protrudes from the inner surface 9 or 8 opposite to the inner surface 8 or 9 from which each of said first inclined bosses 17 protrudes.

According to an embodiment, said first inclined boss 17 is a plurality of first inclined bosses 17.

Said second inclined boss 18 is a plurality of second inclined bosses 18.

Each second inclined boss 18 protrudes from the same inner surface 8 or 9 of each first inclined boss 17.

According to an embodiment, said at least a first inclined boss 17 and said at least a second inclined boss 18 form a “V” shape.

According to an embodiment, said at least a first inclined boss 17 and said at least a second inclined boss 18 form a “V” shape in which an end portion thereof facing the inner band edge 11 is joined by joining said end portions.

According to an embodiment, said at least a first inclined boss 17 and said at least a second inclined boss 18 form a “V” shape in which an end portion thereof is joined and a boss pin 22 which joins said two opposite plates 3, 4 is provided between said at least a first inclined boss 17 and said at least a second inclined boss 18.

According to an embodiment, said at least a first inclined boss 17 and said at least a second inclined boss 18 form a “V” shape in which an end portion thereof is joined and a boss pin 22 which joins said two opposite plates 3, 4 is provided between said first inclined boss 17 and said at least a second inclined boss 18; and where said boss pin 22 partially interpenetrates said at least a first inclined boss 17 and said at least a second inclined boss 18.

According to an embodiment, said at least a first inclined boss 17 and said at least a second inclined boss 18 are mutually spaced apart forming a boss passage 21 and where the extension of the ventilation duct 7 in said boss passage 21 in the axial direction A-A expands until it reaches the opposite plate inner surfaces 8, 9.

According to an embodiment, a disc brake disc 23 comprises a braking band 1 according to any one of the embodiments described above, and a driving bell 20.

According to an embodiment, the pins 13, 14 connecting the two plates 3, 4 to each other are arranged in the ventilation duct 7 in a quincunx pattern.

According to an embodiment, the pins 13, 14 and the portions of the radial connection extensions 19 which connect the two plates 3, 4 to each other are arranged in the ventilation duct 7 in a quincunx pattern.

According to an embodiment, the section in a plane comprising a radial direction R-R and a circumferential direction C-C of said at least one inclined boss 17, 18 is rhomboidal in shape. The airflow entering the ventilation duct is promoted by virtue of this rhomboidal shape.

According to an embodiment, the section in a plane comprising a radial direction R-R and circumferential direction C-C of said at least one inclined boss 17, 18 is rounded rhomboidal in shape and elongated as a drop.

According to an embodiment, said at least a first and/or second inclined boss 17, 18 has an elongated extension along a boss direction B1 and/or B2. Said boss direction B1 and/or B2 is oriented towards the inner radial end of the pin 14 most adjacent to said inclined boss 17, 18. The ventilation within the ventilation duct 7 is further promoted by virtue of this aligned inclination between inclined boss 17, 18, and pin 14.

According to an embodiment, the pins 13, 14 and the bosses 17, 18 are arranged in circumferential rows.

According to an embodiment, the pins 13, 14 and the bosses 17, 18 of each row are sixteen in number.

According to a general embodiment, said disc brake disc 30 further comprises at least one braking band 1.

Said braking band 1 comprises a band body 2 adapted to rotate about a rotation axis X-X, said rotation axis defines an axial direction A-A either coinciding with or parallel to said rotation axis X-X, a radial direction R-R orthogonal to said rotation axis X-X and orthogonal to any axial direction A-A incident with said radial direction R-R, as well as a circumferential direction C-C orthogonal to both said axial direction A-A and said radial direction R-R in any intersection point.

Said braking band 1 comprises two opposite plates 3, 4, which define opposite braking surfaces 5, 6 and substantially flat opposite inner surfaces 8, 9; a ventilation duct 7 delimited by said substantially flat opposite inner surfaces 8, 9 is provided between said plates 3, 4.

Said ventilation duct 7 has a predetermined radial ventilation duct extension 10 extended in a radial direction R-R extending from an inner band edge 11 to an outer band edge 12.

Said plates 3, 4 are connected to each other by pins 13, 14.

Each of said pins 13, 14 has a radial pin extension 15, 16 of smaller magnitude than said radial ventilation duct extension 10.

Said disc brake 30 further comprises a driving bell 20 adapted to connect to a stub axle of a vehicle;
in said ventilation duct 7 there is at least one radial connection extension 19 which connects said two opposite plates 3, 4 and connects said braking band 1 to said driving bell 20 so that said braking band 1 and said driving bell 20 are in one piece.

Said at least one radial connection extension 19 has a longitudinal extension 23 of radial connection extension, where said longitudinal extension 23 of radial connection extension is smaller than the said radial ventilation duct extension 10, so as to leave said pins 15, 14 at least partially facing each other in the circumferential direction C-C.

Said at least one radial connection extension 19 faces, with a portion thereof and on both the circumferentially directed sides C-C thereof, two axial through-windows 24, which are through openings directed in an axial direction A-A and both communicating with said ventilation duct 7.

According to an embodiment, the driving bell 20 has at least two bell window surfaces 25, which extend in a circumferential direction and each facing one of said two axial through-windows 24.

According to an embodiment, at least one of said at least two bell window surfaces 25 is inclined with respect to said axial direction A-A and radial direction R-R so that the shape of at least one of said two axial through-windows 24 widens traversing it in the axial direction A-A passing from one side of the disc brake disc 30 towards the other side of the disc brake disc 30.

According to an embodiment, at least one of said at least two bell window surfaces 25 is inclined with respect to said axial direction A-A and radial direction R-R so that the shape of at least one of said two axial through-windows 24 widens traversing it in the axial direction A-A passing from one plate 3 or 4 towards the other plate 4 or 3.

According to an embodiment, said disc brake disc 30 comprises a plurality of radial bell connecting extensions 19; said radial bell connecting extensions 19 are circumferentially distributed and delineate a plurality of axial through-windows 24.

A bell window surface 25 is between each radial extension 19 and an adjacent radial extension 19; said bell window surfaces 25 extend in a circumferential direction and each of said bell window surfaces 25 faces one of said axial through-windows 24.

According to an embodiment, said driving bell 20 comprises a bell connecting portion 26 facing said braking band 1 in a radial direction R-R; where said bell connecting portion 26 comprises at least one circumferential channel 29 which forms a channel in said bell connecting portion 26.

According to an embodiment, said driving bell 20 comprises a bell connecting portion 26 facing said braking band 1 in a radial direction R-R; where said bell connecting portion 26 comprises two circumferential channels 29 which form two channels in said bell connecting portion 26.

According to an embodiment, said driving bell 20 comprises a bell connecting portion 26 facing said braking band 1 in a radial direction R-R; where said bell connecting portion 26 comprises at least one circumferential bell rib 31 which protrudes towards the ventilation duct 7 avoiding touching the plates 3, 4.

According to an embodiment, said driving bell 20 comprises a bell connecting portion 26 facing said braking band 1 in a radial direction R-R; where said bell connecting portion 26 comprises at least one circumferential bell rib 31 which protrudes entering into said ventilation duct 7 avoiding touching the plates 3, 4.

According to an embodiment, said driving bell 20 comprises a bell connecting portion 26 facing said braking band 1 in a radial direction R-R; where said bell connecting portion 26 comprises at least one circumferential bell rib 31 which protrudes entering into said ventilation duct 7 remaining overhanging.

According to an embodiment, said at least one circumferential bell rib 31 connects to said bell connecting portion 26.

According to an embodiment, said at least one circumferential bell rib 31 is blunt or rounded in shape.

According to an embodiment, said driving bell 20 comprises a bell connecting portion 26 facing said braking band 1 in a radial direction R-R; where said bell connecting portion 26 comprises at least one circumferential channel 29 which forms a channel in said bell connecting portion 26.

Said at least one circumferential bell rib 31 connects and runs alongside said at least one circumferential channel 29.

According to an embodiment, said disc brake disc 30 comprises a side facing the vehicle wheel or wheel side of the disc brake disc 30; and a side facing the vehicle or vehicle side of the disc brake disc 30.

Said bell connecting portion 26 with circumferential bell rib 31 forms two opposite ventilation duct access openings 32, 33; a first opening 32 which opens from the wheel side of the disc brake disc 30, and a second opposite opening 33 which opens from the vehicle side of the disc brake disc 30.

According to an embodiment, said first opening 32 which opens from the wheel side of the disc brake disc 30 comprises smaller opening dimensions as compared to the second opposite opening 33 which opens from the vehicle side of the disc brake disc 30.

According to an embodiment, said driving bell 20 comprises a bell connecting portion 26 facing said braking band 1 in a radial direction R-R; where said bell connecting portion 26 comprises at least one circumferential channel 29 which forms a channel in said bell connecting portion 26.

Said first opening 32 which opens from the wheel side of the disc brake disc 30 is delimited by said at least one circumferential channel 29 and said at least one circumferential bell rib 31.

According to an embodiment, at least one of said ventilation duct access openings 32 of said axial through-window 24 is made by chip removal.

According to a general embodiment, said disc brake disc 30 further comprises at least one braking band 1.

Said braking band 1 comprises a band body 2 adapted to rotate about a rotation axis X-X, said rotation axis defines an axial direction A-A either coinciding with or parallel to said rotation axis X-X, a radial direction R-R orthogonal to said rotation axis X-X and orthogonal to any axial direction A-A incident with said radial direction R-R, as well as a circumferential direction C-C orthogonal to both said axial direction A-A and said radial direction R-R in any intersection point.

Said braking band 1 comprises two opposite plates 3, 4, which define opposite braking surfaces 5, 6 and substantially flat opposite inner surfaces 8, 9; a ventilation duct 7 delimited by said substantially flat opposite inner surfaces 8, 9 is provided between said plates 3, 4.

Said ventilation duct 7 has a predetermined radial ventilation duct extension 10 extended in a radial direction R-R extending from an inner band edge 11 to an outer band edge 12.

Said plates 3, 4 are connected to each other by pins 13, 14.

Each of said pins 13, 14 has a radial pin extension 15, 16 of smaller magnitude than said radial ventilation duct extension 10.

Said disc brake 30 further comprises a driving bell 20 adapted to connect to a stub axle of a vehicle.

In said ventilation duct 7 there is at least one radial connection extension 19 which connects said two opposite plates 3, 4 and connects said braking band 1 to said driving bell 20 so that said braking band 1 and said driving bell 20 are in one piece.

Said at least one radial connection extension 19 has a longitudinal extension 23 of radial connection extension, where said longitudinal extension 23 of radial connection extension is smaller than the said radial ventilation duct extension 10, so as to leave said pins 15, 14 at least partially facing each other in the circumferential direction C-C.

Said at least one radial connection extension 19 faces, with a portion thereof and on both the circumferentially directed sides C-C thereof, two axial through-windows 24, which are through openings directed in an axial direction A-A and both communicating with said ventilation duct 7.

Close to said inner band edge 11, at least a first inclined boss 17 protrudes from at least one of said opposite inner surfaces 9, 8 towards the inside of said ventilation duct 7 without reaching the opposite inner surface 8, 9; said at least a first inclined boss 17 forms a narrowing in said ventilation duct 7.

Said at least a first inclined boss 17 has an elongated extension along a first boss direction B1.

Said first boss direction B1 is inclined with respect to said radial direction R-R as well as with respect to said circumferential direction C-C forming a first acute angle A1 with said radial direction R-R.

According to an embodiment, close to said inner band edge 11, at least a second inclined boss 18 protrudes from at least one of said opposite inner surfaces 8, 9 towards the inside of said ventilation duct 7 without reaching the opposite inner surface 9, 8; said at least a second inclined boss 18 forms a narrowing in said ventilation duct 7.

Said at least a second inclined boss 18 has an elongated extension along a second boss direction B2.

Said second boss direction B2 is inclined with respect to said radial direction R-R as well as with respect to said circumferential direction C-C forming a second acute angle A1 with said radial direction R-R.

The inclination of said second boss direction B2 with respect to the radial direction R-R is opposite to the inclination of said first boss direction B1 with respect to the same radial direction R-R.

According to an embodiment, said disc brake disc 30 comprises a plurality of radial bell connecting extensions 19; said radial bell connecting extensions 19 are circumferentially distributed and delineate a plurality of axial through-windows 24.

According to an embodiment, at least one pin 14 has at least one pin foot extending in circumferential and radial directions away from said pin 14, forming an elevation with respect to the inner surface 8, 9 and thus a narrowing of the ventilation duct 7. According to an embodiment, in a view along the axial direction A-A, said pin foot has a shape with radiused extensions, e.g., with circumferential radii and a more extended radius in the radial direction R-R.

According to a general embodiment, said disc brake disc 30 further comprises at least one braking band 1.

Said braking band 1 comprises a band body 2 adapted to rotate about a rotation axis X-X, said rotation axis defines an axial direction A-A either coinciding with or parallel to said rotation axis X-X, a radial direction R-R orthogonal to said rotation axis X-X and orthogonal to any axial direction A-A incident with said radial direction R-R, as well as a circumferential direction C-C orthogonal to both said axial direction A-A and said radial direction R-R in any intersection point.

Said braking band 1 comprises two opposite plates 3, 4 defining opposite braking surfaces 5, 6 and opposite substantially flat inner surfaces 8, 9.

A ventilation duct 7 delimited by said opposed substantially flat inner surfaces 8, 9 is provided between said plates 3, 4.

Said ventilation duct 7 has a predetermined radial ventilation duct extension 10 extended in a radial direction R-R extending from an inner band edge 11 to an outer band edge 12.

Said disc brake 30 further comprises a driving bell 20 adapted to connect to a stub axle of a vehicle.

Said driving bell 20 being connected to said braking band 1.

Between said braking band 1 and said driving bell 20 there are axial through-windows 24 which are through openings directed in axial direction A-A and communicating with said ventilation duct 7.

Said driving bell 20 comprises a bell connecting portion 26 facing said braking band 1 in a radial direction-R.

Said bell connecting portion 26 comprises at least one circumferential bell rib 31 which protrudes towards the ventilation duct 7 avoiding touching the plates 3, 4.

According to an embodiment, said plates 3, 4 are connected to each other by pins 13, 14.

Each of said pins 13, 14 has a radial pin extension 15, 16 of smaller magnitude than said radial ventilation duct extension 10.

According to an embodiment, in said ventilation duct 7 there is at least one radial connection extension 19 which connects said two opposite plates 3, 4 and connects said braking band 1 to said driving bell 20 so that said braking band 1 and said driving bell 20 are in one piece.

Said at least one radial connection extension 19 has a longitudinal extension 23 of radial connection extension, where said longitudinal extension 23 of radial connection extension is smaller than the said radial ventilation duct extension 10, so as to leave said pins 15, 14 at least partially facing each other in the circumferential direction C-C.

Said at least one radial connection extension 19 faces, with a portion thereof and on both the circumferentially directed sides C-C thereof, two axial through-windows 24, which are through openings directed in an axial direction A-A and communicating with said ventilation duct 7.

According to an embodiment, said driving bell 20 comprises a bell connecting portion 26 facing said braking band 1 in a radial direction R-R; where said bell connecting portion 26 comprises said at least one circumferential bell rib 31 which protrudes entering into said ventilation duct 7 avoiding touching the plates 3, 4.

According to an embodiment, said driving bell 20 comprises a bell connecting portion 26 facing said braking band 1 in a radial direction R-R; where said bell connecting portion 26 comprises at least one circumferential bell rib 31 which protrudes entering into said ventilation duct 7 remaining overhanging.

According to an embodiment, said at least one circumferential bell rib 31 connects to said bell connecting portion 26.

According to an embodiment, said at least one circumferential bell rib 31 is blunt or rounded in shape.

According to an embodiment, said driving bell 20 comprises a bell connecting portion 26 facing said braking band 1 in a radial direction R-R; where said bell connecting portion 26 comprises at least one circumferential channel 29 which forms a channel in said bell connecting portion 26.

Said at least one circumferential bell rib 31 connects and runs alongside said at least one circumferential channel 29.

According to an embodiment, said disc brake disc 30 comprises a side facing the vehicle wheel or wheel side of the disc brake disc 30; and a side facing the vehicle or vehicle side of the disc brake disc 30.

Said bell connecting portion 26 with circumferential bell rib 31 forms two opposite ventilation duct access openings 32, 33; a first opening 32 which opens from the wheel side of the disc brake disc 30, and a second opposite opening 33 which opens from the vehicle side of the disc brake disc 30.

According to an embodiment, said first opening 32 which opens from the wheel side of the disc brake disc 30 comprises smaller opening dimensions as compared to the second opposite opening 33 which opens from the vehicle side of the disc brake disc 30.

According to an embodiment, said driving bell 20 comprises a bell connecting portion 26 facing said braking band 1 in a radial direction R-R; where said bell connecting portion 26 comprises at least one circumferential channel 29 which forms a channel in said bell connecting portion 26.

Said first opening 32 which opens from the wheel side of the disc brake disc 30 is delimited by said at least one circumferential channel 29 and said at least one circumferential bell rib 31.

According to an embodiment, said disc brake disc 30 comprises a plurality of radial bell connecting extensions 19.

Said radial bell connecting extensions 19 are circumferentially distributed and delineate a plurality of axial through-windows 24; and where a circumferential bell rib 31 is between each radial extension 19 and an adjacent radial extension 19.

In order to meet specific, contingent needs, those skilled in the art may make several changes and adaptations to the above-described embodiments and can replace elements with others which are functionally equivalent, without however departing from the scope of the following claims.

According to an embodiment, a disc brake disc 30 comprises
a braking band 1, where
said braking band 1 comprises a band body 2 adapted to rotate about a rotation axis X-X, said rotation axis defines an axial direction A-A either coinciding with or parallel to said rotation axis X-X, a radial direction R-R orthogonal to said rotation axis X-X and orthogonal to any axial direction A-A incident with said radial direction R-R, as well as a circumferential direction C-C orthogonal to both said axial direction A-A and said radial direction R-R in any intersection point;
said braking band 1 comprises two opposite plates 3, 4, which define opposite braking surfaces 5, 6 and substantially flat opposite inner surfaces 8, 9; a ventilation duct 7 delimited by said substantially flat opposite inner surfaces 8, 9 is provided between said plates 3, 4;
said ventilation duct 7 has a predetermined radial ventilation duct extension 10 extended in a radial direction R-R extending from an inner band edge 11 to an outer band edge 12;
said plates 3, 4 are connected to each other by pins 13, 14;
each of said pins 13, 14 has a radial pin extension 15, 16 of smaller magnitude than said radial ventilation duct extension 10;
and where
said disc brake 30 further comprises a driving bell 20 adapted to connect to a stub axle of a vehicle;
and where
in said ventilation duct 7 there is at least one radial connection extension 19 which connects said two opposite plates 3, 4 and connects said braking band 1 to said driving bell 20 so that said braking band 1 and said driving bell 20 are in one piece;
said at least one radial connection extension 19 has a longitudinal extension 23 of radial connection extension, where said longitudinal extension 23 of radial connection extension is smaller than said radial ventilation duct extension 10, so as to leave said pins 15, 14 at least partially facing each other in the circumferential direction C-C;
and where
said at least one radial connection extension 19 faces, with a portion thereof and on both the circumferentially directed sides C-C thereof, two axial through-windows 24, which are through openings directed in an axial direction A-A and both communicating with said ventilation duct 7;
close to said inner band edge 11, at least a first inclined boss 17 protrudes from at least one of said opposite inner surfaces 9, 8 towards the inside of said ventilation duct 7 without reaching the opposite inner surface 8, 9; said at least a first inclined boss 17 forms a narrowing in said ventilation duct 7;
said at least a first inclined boss 17 has an elongated extension along a first boss direction B1;
said first boss direction B1 being inclined with respect to said radial direction R-R as well as with respect to said circumferential direction C-C forming a first acute angle A1 with said radial direction R-R.

According to an embodiment, close to said inner band edge 11, at least a second inclined boss 18 protrudes from at least one of said opposite inner surfaces 8, 9 towards the inside of said ventilation duct 7 without reaching the opposite inner surface 9, 8; said at least a second inclined boss 18 forms a narrowing in said ventilation duct 7;
said at least a second inclined boss 18 has an elongated extension along a second boss direction B2;
said second boss direction B2 being inclined with respect to said radial direction R-R as well as with respect to said circumferential direction C-C forming a second acute angle A1 with said radial direction R-R;
and where
the inclination of said second boss direction B2 with respect to the radial direction R-R is opposite to the inclination of the first boss direction B1 with respect to the same radial direction R-R.

According to an embodiment, said at least a second inclined boss 18 protrudes from the same inner surface 8 or 9 of said at least a first inclined boss 17;
and/or where
said at least a second inclined boss 18 faces said at least a first inclined boss 17 in a circumferential direction C-C.

According to an embodiment, a radial connection extension 19 which connects said braking band to a driving bell 20 adapted to connect said braking band to a stub axle of a vehicle is interposed in the circumferential direction C-C between said at least a second inclined boss 18 and said at least a first inclined boss 17.

According to an embodiment, said at least a second inclined boss 18 protrudes from the inner surface 9 or 8 opposite to the inner surface 8 or 9 from which said at least a first inclined boss 17 protrudes.

According to an embodiment, said first inclined boss 17 is a plurality of first inclined bosses 17;
said second inclined boss 18 is a plurality of second inclined bosses 18;
and where
each of said second inclined bosses 18 protrudes from the inner surface 9 or 8 opposite to the inner surface 8 or 9 from which each of said first inclined bosses 17 protrudes;
or where
said first inclined boss 17 is a plurality of first inclined bosses 17;
said second inclined boss 18 is a plurality of second inclined bosses 18;
each second inclined boss 18 protrudes from the same inner surface 8 or 9 of each first inclined boss 17.

According to an embodiment, said at least a first inclined boss 17 and said at least a second inclined boss 18 form a “V” shape;
or where
said at least a first inclined boss 17 and said at least a second inclined boss 18 form a “V” shape in which the end portion thereof facing the inner band edge 11 is joined;
or where
said at least a first inclined boss 17 and said at least a second inclined boss 18 form a “V” shape in which an end portion thereof is joined and a boss pin 22 is provided between said at least a first inclined boss 17 and said at least a second inclined boss 18;
or where
said at least a first inclined boss 17 and said at least a second inclined boss 18 form a “V” shape in which an end portion thereof is joined and a boss pin 22 which joins said plates 3, 4 is provided between said at least a first inclined boss 17 and said at least a second inclined boss 18; and where said boss pin 22 partially interpenetrates said at least a first inclined boss 17 and said at least a second inclined boss 18.

According to an embodiment, said disc brake disc 30 comprises a plurality of radial bell connecting extensions 19; said radial bell connecting extensions 19 are circumferentially distributed and delineate a plurality of axial through-windows 24.

According to an embodiment, said driving bell 20 comprises a bell connecting portion 26 facing said braking band 1 in a radial direction R-R; where said bell connecting portion 26 comprises at least one circumferential bell rib 31 which protrudes towards the ventilation duct 7 avoiding touching the plates 3, 4.

According to an embodiment, a disc brake disc 30 comprises
a braking band 1, where
said braking band 1 comprises a band body 2 adapted to rotate about a rotation axis X-X, said rotation axis defines an axial direction A-A either coinciding with or parallel to said rotation axis X-X, a radial direction R-R orthogonal to said rotation axis X-X and orthogonal to any axial direction A-A incident with said radial direction R-R, as well as a circumferential direction C-C orthogonal to both said axial direction A-A and said radial direction R-R in any intersection point; where
said braking band 1 comprises two opposite plates 3, 4, which define opposite braking surfaces 5, 6 and substantially flat opposite inner surfaces 8, 9; a ventilation duct 7 delimited by said substantially flat opposite inner surfaces 8, 9 is provided between said plates 3, 4;

said ventilation duct 7 has a predetermined radial ventilation duct extension 10 extended in a radial direction R-R extending from an inner band edge 11 to an outer band edge 12;
and where
said disc brake 30 further comprises a driving bell 20 adapted to connect to a stub axle of a vehicle;

said driving bell 20 being connected to said braking band 1;
where
between said braking band 1 and said driving bell 20 there are axial through-windows 24 which are through openings directed in the axial direction A-A and communicating with said ventilation duct 7; and where
said driving bell 20 comprises a bell connecting portion 26 facing said braking band 1 in a radial direction R-R; and where
said bell connecting portion 26 comprises at least one circumferential bell rib 31 which protrudes towards the ventilation duct 7 avoiding touching the plates 3, 4.

1. According to an embodiment, said plates 3, 4 are connected to each other by pins 13, 14; and where
each of said pins 13, 14 has a radial pin extension 15, 16 of smaller magnitude than said radial ventilation duct extension 10.

According to an embodiment, in said ventilation duct 7 there is at least one radial connection extension 19 which connects said two opposite plates 3, 4 and connects said braking band 1 to said driving bell 20 so that said braking band 1 and said driving bell 20 are in one piece; and where
said at least one radial connection extension 19 has a longitudinal extension 23 of radial connection extension, where said longitudinal extension 23 of radial connection extension is smaller than said radial ventilation duct extension 10, so as to leave said pins 15, 14 at least partially facing each other in the circumferential direction C-C; and where
said at least one radial connection extension 19 faces, with a portion thereof and on both the circumferentially directed sides C-C thereof, two axial through-windows 24, which are through openings directed in an axial direction A-A and communicating with said ventilation duct 7.

According to an embodiment, said driving bell 20 comprises a bell connecting portion 26 facing said braking band 1 in a radial direction R-R; where said bell connecting portion 26 comprises said at least one circumferential bell rib 31 which protrudes entering into said ventilation duct 7 avoiding touching the plates 3, 4.

According to an embodiment, said driving bell 20 comprises a bell connecting portion 26 facing said braking band 1 in a radial direction R-R; where said bell connecting portion 26 comprises at least one circumferential bell rib 31 which protrudes entering into said ventilation duct 7 remaining overhanging.

According to an embodiment, said at least one circumferential bell rib 31 connects to said bell connecting portion 26;
or where
said at least one circumferential bell rib 31 is blunt or rounded in shape.

According to an embodiment, said driving bell 20 comprises a bell connecting portion 26 facing said braking band 1 in a radial direction R-R; where said bell connecting portion 26 comprises at least one circumferential channel 29 which forms a channel in said bell connecting portion 26; and where
said at least one circumferential bell rib 31 connects and runs alongside said at least one circumferential channel 29.

According to an embodiment, said disc brake disc 30 comprises a side facing the vehicle wheel or wheel side of the disc brake disc 30; and a side facing the vehicle or vehicle side of the disc brake disc 30; and where
said bell connecting portion 26 with circumferential bell rib 31 forms two opposite ventilation duct access openings 32, 33; a first opening 32 which opens from the wheel side of the disc brake disc 30, and a second opposite opening 33 which opens from the vehicle side of the disc brake disc 30.

According to an embodiment, said first opening 32 which opens from the wheel side of the disc brake disc 30 comprises smaller opening dimensions as compared to said second opposite opening 33 which opens from the vehicle side of the disc brake disc 30;
and/or where
said driving bell 20 comprises a bell connecting portion 26 facing said braking band 1 in a radial direction R-R; where said bell connecting portion 26 comprises at least one circumferential channel 29 which forms a channel in said bell connecting portion 26; and where
said first opening 32 which opens from the wheel side of the disc brake disc 30 is delimited by said at least one circumferential channel 29 and said at least one circumferential bell rib 31.

According to an embodiment, said disc brake disc 30 comprises a plurality of radial bell connecting extensions 19; said radial bell connecting extensions 19 are circumferentially distributed and delineate a plurality of axial through-windows 24; and where a circumferential bell rib 31 is between each radial extension 19 and an adjacent radial extension 19.

According to an embodiment, a braking band 1 of a brake disc of a disc brake, where
said braking band 1 comprises a band body 2 adapted to rotate about a rotation axis X-X, said rotation axis defines an axial direction A-A either coinciding with or parallel to said rotation axis X-X, a radial direction R-R orthogonal to said rotation axis X-X and orthogonal to any axial direction A-A incident with said radial direction R-R, as well as a circumferential direction C-C orthogonal to both said axial direction A-A and said radial direction R-R in any intersection point;
said braking band 1 comprises two opposite plates 3, 4, which define opposite braking surfaces 5, 6 and substantially flat opposite inner surfaces 8, 9; a ventilation duct 7 delimited by said substantially flat opposite inner surfaces 8, 9 is provided between said plates 3, 4;
said ventilation duct 7 has a predetermined radial ventilation duct extension 10 extended in a radial direction R-R extending from an inner band edge 11 to an outer band edge 12;
said plates 3, 4 are connected to each other by pins 13, 14;
each of said pins 13, 14 has a radial pin extension 15, 16 of smaller magnitude than said radial ventilation duct extension 10;
where

close to said inner band edge 11, at least a first inclined boss 17 protrudes from at least one of said opposite inner surfaces 9, 8 towards the inside of said ventilation duct 7 without reaching the opposite inner surface 8, 9; said at least a first inclined boss 17 forms a narrowing in said ventilation duct 7;
said at least a first inclined boss 17 has an elongated extension along a first boss direction B1;

said first boss direction B1 being inclined with respect to said radial direction R-R as well as with respect to said circumferential direction C-C forming a first acute angle A1 with said radial direction R-R;
close to said inner band edge 11, at least a second inclined boss 18 protrudes from at least one of said opposite inner surfaces 8, 9 towards the inside of said ventilation duct 7 without reaching the opposite inner surface 9, 8; said at least a second inclined boss 18 forms a narrowing in said ventilation duct 7;
said at least a second inclined boss 18 has an elongated extension along a second boss direction B2;
said second boss direction B2 being inclined with respect to said radial direction R-R as well as with respect to said circumferential direction C-C forming a second acute angle A1 with said radial direction R-R;
and where
the inclination of said second boss direction B2 with respect to the radial direction R-R is opposite to the inclination of the first boss direction B1 with respect to the same radial direction R-R.

According to an embodiment, said at least a second inclined boss 18 protrudes from the same inner surface 8 or 9 of said at least a first inclined boss 17.

According to an embodiment, said at least a second inclined boss 18 faces said at least a first inclined boss 17 in a circumferential direction C-C.

According to an embodiment, a radial connection extension 19 which connects said braking band to a driving bell 20 adapted to connect said braking band to a stub axle of a vehicle is interposed in the circumferential direction C-C between said at least a second inclined boss 18 and said at least a first inclined boss 17.

According to an embodiment, said at least a second inclined boss 18 protrudes from the inner surface 9 or 8 opposite to the inner surface 8 or 9 from which said at least a first inclined boss 17 protrudes.

According to an embodiment, said first inclined boss 17 is a plurality of first inclined bosses 17;
said second inclined boss 18 is a plurality of second inclined bosses 18;
and where
each of said second inclined bosses 18 protrudes from the inner surface 9 or 8 opposite to the inner surface 8 or 9 from which each of said first inclined bosses 17 protrudes.

According to an embodiment, said first inclined boss 17 is a plurality of first inclined bosses 17;
said second inclined boss 18 is a plurality of second inclined bosses 18;
and where
each second inclined boss 18 protrudes from the same inner surface 8 or 9 of each first inclined boss 17.

According to an embodiment, said at least a first inclined boss 17 and said at least a second inclined boss 18 form a “V” shape;
or where

said at least a first inclined boss 17 and said at least a second inclined boss 18 form a “V” shape in which an end portion thereof facing the inner band edge 11 is joined by joining said end portions;
or where
said at least a first inclined boss 17 and said at least a second inclined boss 18 form a “V” shape in which an end portion thereof is joined and a boss pin 22 which joins said two opposite plates 3, 4 is provided between said at least a first inclined boss 17 and said at least a second inclined boss 18;
or where
said at least a first inclined boss 17 and said at least a second inclined boss 18 form a “V” shape in which an end portion thereof is joined and a boss pin 22 which joins said two opposite plates 3, 4 is provided between said first inclined boss 17 and said at least a second inclined boss 18; and where said boss pin 22 partially interpenetrates said at least a first inclined boss 17 and said at least a second inclined boss 18.

According to an embodiment, said at least a first inclined boss 17 and said at least a second inclined boss 18 are mutually spaced apart forming a boss passage 21 and where the extension of the ventilation duct 7 in said boss passage 21 in the axial direction A-A expands until it reaches the opposite plate inner surfaces 8, 9.

According to an embodiment, a disc brake disc 23 comprises a braking band 1 according to any one of the preceding embodiments, and a driving bell 20.

### LIST OF REFERENCE SIGNS

1 braking band
2 band body
3 first plate
4 second plate
5 first braking surface
6 second braking surface
7 ventilation duct
8 first flat inner surface of first plate
9 second flat inner surface of second plate
10 radial ventilation duct extension
11 inner band edge
12 outer band edge
13 outer row pin
14 inner row pin
15 radial extension of outer pin
16 radial extension of inner pin
17 first inclined boss
18 second inclined boss
19 radial bell connecting extension
20 driving bell
21 boss passage
22 row pin proximal to inner band edge or boss pin
23 longitudinal extension of radial connection extension
24 axial through-window
25 bell window surface
26 bell connecting portion
29 circumferential channel
30 disc brake disc
31 circumferential bell rib
32 wheel-side ventilation duct access opening
33 vehicle-side ventilation duct access opening
A-A axial direction
X-X rotation axis
R-R radial direction
C-C circumferential direction
B1 first boss direction
B2 second boss direction
A1 first acute angle between first boss direction and radial direction
A2 second acute angle between second boss direction and radial direction

1-10. (canceled)

11. A disc brake disc comprising
a braking band, wherein
said braking band comprises a band body adapted to rotate about a rotation axis, said rotation axis defines an axial direction either coinciding with or parallel to said rotation axis, a radial direction orthogonal to said rotation axis and orthogonal to any axial direction incident with said radial direction, as well as a circumferential direction orthogonal to both said axial direction and said radial direction in any intersection point;
said braking band comprises two opposite plates, which define opposite braking surfaces and substantially flat opposite inner surfaces; a ventilation duct delimited by said substantially flat opposite inner surfaces is provided between said plates;
said ventilation duct has a predetermined radial ventilation duct extension extended in a radial direction extending from an inner band edge to an outer band edge;
said plates are connected to each other by pins;
each of said pins has a radial pin extension of smaller magnitude than said radial ventilation duct extension;
and wherein
said disc brake further comprises a driving bell adapted to connect to a stub axle of a vehicle;
in said ventilation duct there is at least one radial connection extension which connects said two opposite plates and connects said braking band to said driving bell so that said braking band and said driving bell are in one piece;
said at least one radial connection extension has a longitudinal extension of radial connection extension, wherein said longitudinal extension of radial connection extension is smaller than the extension of said radial ventilation duct extension, so as to leave said pins at least partially facing each other in the circumferential direction;
characterized in that
said at least one radial connection extension faces, with a portion thereof and on both the circumferentially directed sides thereof, two axial through windows, which are through openings directed in an axial direction and both communicating with said ventilation duct.

12. A disc brake disc according to claim 11, wherein
the driving bell has at least two bell window surfaces, which extend in a circumferential direction and each facing one of said two axial through windows.

13. A disc brake disc according to claim 12, wherein
at least one of said at least two bell window surfaces is inclined with respect to said axial and radial directions so that:
the shape of at least one of said two axial through windows widens traversing it in the axial direction passing from one side of the disc brake disc towards the other side of the disc brake disc;
or
the shape of at least one of said two axial through windows widens traversing it in the axial direction passing from one plate towards the other plate.

14. A disc brake disc according to claim 11, wherein
said disc brake disc comprises a plurality of radial bell connecting extensions; said radial bell connecting extensions are circumferentially distributed and delineate a plurality of axial through windows; and wherein a bell window surface is between each radial extension and an adjacent radial extension; said bell window surfaces extend in a circumferential direction and each of said bell window surfaces faces one of said axial through windows.

15. A disc brake disc according to claim 11, wherein
said driving bell comprises a bell connecting portion facing said braking band in a radial direction; wherein said bell connecting portion comprises at least one circumferential channel which forms a channel in said bell connecting portion;
or wherein
said driving bell comprises a bell connecting portion facing said braking band in a radial direction; wherein said bell connecting portion comprises two circumferential channels which form two channels in said bell connecting portion.

16. A disc brake disc according to claim 11, wherein
said driving bell comprises a bell connecting portion facing said braking band in a radial direction; wherein said bell connecting portion comprises at least one circumferential bell rib which protrudes towards the ventilation duct avoiding touching the plates;
or
said driving bell comprises a bell connecting portion facing said braking band in a radial direction; wherein said bell connecting portion comprises at least one circumferential bell rib which protrudes entering into said ventilation duct avoiding touching the plates;
or
said driving bell comprises a bell connecting portion facing said braking band in a radial direction; wherein said bell connecting portion comprises at least one circumferential bell rib which protrudes entering into said ventilation duct remaining overhanging.

17. A disc brake disc according to claim 16, wherein
said at least one circumferential bell rib connects to said bell connecting portion;
or wherein
said at least one circumferential bell rib is blunt or rounded in shape;
or wherein
said driving bell comprises a bell connecting portion facing said braking band in a radial direction; wherein said bell connecting portion comprises at least one circumferential channel which forms a channel in said bell connecting portion; and wherein
said at least one circumferential bell rib connects and runs alongside said at least one circumferential channel.

18. A disc brake disc according to claim 17, wherein
said disc brake disc comprises a side facing the vehicle wheel or wheel side of the disc brake disc; and a side facing the vehicle or vehicle side of the disc brake disc; and wherein
said bell connecting portion with circumferential bell rib forms two opposite ventilation duct access openings; a first opening which opens from the wheel side of the disc brake disc, and a second opposite opening which opens from the vehicle side of the disc brake disc

19. A disc brake disc according to claim 18, wherein
said first opening which opens from the wheel side of the disc brake disc comprises smaller opening dimensions as compared to said second opposite opening which opens from the vehicle side of the disc brake disc.

20. A disc brake disc according to claim 18, wherein
said driving bell comprises a bell connecting portion facing said braking band in a radial direction; wherein said bell connecting portion comprises at least one circumferential channel which forms a channel in said bell connecting portion; and wherein
said first opening which opens from the wheel side of the disc brake disc is delimited by said at least one circumferential channel and said at least one circumferential bell rib.
